(19) United States
(12) Patent Application Publication
(10) Pub. No.: US 2016/0164999 A1
(43) Pub. Date: Jun. 9, 2016

(54) HYBRID WEB STORAGE MODEL

(71) Applicant: International Business Machines Corporation, Armonk, NY (US)

(72) Inventors: Joshua A. Alger, Raleigh, NC (US); Curtiss J. Howard, Cary, NC (US); Todd E. Kaplinger, Raleigh, NC (US)

(21) Appl. No.: 14/564,447

(22) Filed: Dec. 9, 2014

(51) Int. Cl. H04L 29/08

(52) U.S. Cl. CPC H04L 67/2857; H04L 67/02; H04L 67/16

(57) ABSTRACT

Embodiments of the invention provide for hybrid Web Storage performing mixed utilization of a localStorage object and remote storage. A method for hybrid Web Storage performing mixed utilization of a hypertext markup language (HTML) version 5 localStorage object and remote storage includes receiving a cache request in a key usage engine of a mobile device by an application executing in the mobile device. The method further includes determining in the key usage engine based upon at least detected network connectivity whether to process the cache request in a localStorage object of the mobile device, or to process the cache request in remote storage external from the mobile device over a computer communications network. Finally, the method includes processing the cache request in the localStorage object of the mobile device responsive to a determination by the key usage engine to process the cache request locally, but otherwise processing the cache request in the remote storage.

### BACKGROUND OF THE INVENTION

1. Field of the Invention

The present invention relates to state information storage during client side page processing and more particularly to Web data storage for client side page processing.

2. Description of the Related Art

Page processing refers to the receipt, interpretation and rendering of a markup language defined page in a content browser. The most well-known form of a page processing content browser at present is the venerable Web browser in which Web pages are received, processed and rendered. In a conventional Web browser, a markup language page—typically a page defined according to the hypertext markup language (HTML) markup language specification—can be received, interpreted and rendered in a display of a computer. Integral to the HTML processing capabilities of the Web browser is the cookie feature.

The cookie feature provides for short term data storage of state information for a Web page. Cookies have been used for many reasons including session management, personalization and tracking. However, according to the hypertext transfer protocol (HTTP) specification on statement management, a Web browser in respect to the use of cookies need only support a minimal number of cookies. In particular, according to the HTTP specification, a Web browser is expected only to be able to store three-hundred cookies of four kilobytes each, and only twenty cookies per server or domain.

While the cookie feature of HTML can provide a tempting mechanism for data storage in page processing, for many applications—and in particular in light of advances in the acquisition and transfer of digital information such as digital imagery and audio, a client side mechanism of greater capacity is desirable. The HTML version 5 specification addresses this need in defining “Web Storage”. Web Storage picks up where cookies left off. In this regard, Web Storage provides both a simple application programming interface (API) to getter and setter methods for key/value pairs and also a default disk space quota of no less than five megabytes per fully qualified domain name. Within the HTML version 5 specification, Web Storage provides for two object for storing data on a client. The first object is a “localStorage” object that stores data on the client without expiration. The second object is “sessionStorage” which stores data on a client for the duration of a single session.

Consequently, the Web Storage mechanism allows the page developer to define storage for a page of more than just basic user/session info on the client-side. Rather, the Web Storage mechanism permits the storage of user preference settings, localization data, temporary offline storage for batching server writes and much more. Yet further, data stored according to the Web Storage mechanism can be accessed using the familiar JAVASCRIPT™ scripting language, which permits the developer to leverage client-side scripting to do many things that have traditionally involved server-side programming and relational databases.

### BRIEF SUMMARY OF THE INVENTION

Embodiments of the present invention address deficiencies of the art in respect to Web Storage and provide a novel and non-obvious method, system and computer program product for hybrid Web Storage performing mixed utilization of a localStorage object and remote storage. In an embodiment of the invention, a method for hybrid Web Storage performing mixed utilization of an HTML5 localStorage object and remote storage includes receiving a cache request in a key usage engine of a mobile device by an application executing in the mobile device. The method further includes determining in the key usage engine based upon at least detected network connectivity whether to process the cache request in a localStorage object of the mobile device, or to process the cache request in remote storage external from the mobile device over a computer communications network. Finally, the method includes processing the cache request in the localStorage object of the mobile device responsive to a determination by the key usage engine to process the cache request locally, but otherwise processing the cache request in the remote storage.

In one aspect of the embodiment, the key usage engine determines whether to process the cache request locally in the localStorage object or remotely in remote storage in reference not only to detected network connectivity, but also in reference to a frequency of receipt of the cache request. In another aspect of the embodiment, the key usage engine determines whether to process the cache request locally in the localStorage object or remotely in remote storage in reference not only to detected network connectivity, but also in reference to whether data subject to the cache request is data of interest only to the mobile device or whether data subject to the cache request is data of interest to multiple different applications executing in multiple different mobile devices. In yet another aspect of the embodiment, the cache request is either a hypertext transport protocol (HTTP) PUT request for a particular key-value pair, or an HTTP GET request for a particular key-value pair. In the latter circumstance, the PUT request is processed in the remote storage by way of a store and forward queue.

In another embodiment of the invention, a content retrieval data processing system is configured for hybrid Web Storage performing mixed utilization of a localStorage object and remote storage. The system includes a mobile device that has at least one processor and memory and an application executing in the memory of the mobile device. The system also includes a localStorage object defined in the memory of the mobile device and a key usage engine. The engine includes program code enabled upon execution in the memory of the mobile device to receive a cache request by the application, to determine based upon at least detected network connectivity of the mobile device whether to process the cache request in the localStorage object, or to process the cache request in remote storage external from the mobile device over a computer communications network, and to process the cache request in the localStorage object responsive to a determination to process the cache request locally, but otherwise processing the cache request in the remote storage.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for hybrid Web Storage performing mixed utilization of a localStorage object and remote storage;

FIG. 2 is a schematic illustration of a content retrieval data processing system configured for hybrid Web Storage performing mixed utilization of a localStorage object and remote storage; and,

FIG. 3 is a flow chart illustrating a process for hybrid Web Storage performing mixed utilization of a localStorage object and remote storage.

### DETAILED DESCRIPTION OF THE INVENTION

Embodiments of the invention provide for hybrid Web Storage performing mixed utilization of a localStorage object and remote storage. In accordance with an embodiment of the invention, a localStorage object is configured in a subject mobile device to store different cache keys referring to content stored in remote storage and also referring to content stored locally in a local cache of the subject mobile device. The cache keys referring to content stored in remote storage are synchronized amongst multiple different other mobile devices, each accessing the content. However, only selected content is cached to the remote storage, while other content is cached locally in the subject mobile device. The determination of which content is to be stored in the subject mobile device is made based upon the likelihood content is to be retrieved from the multiple different other mobile devices at the remote storage and the likelihood that content is to be retrieved only locally by the subject mobile device and the availability of network connectivity to the subject mobile device.

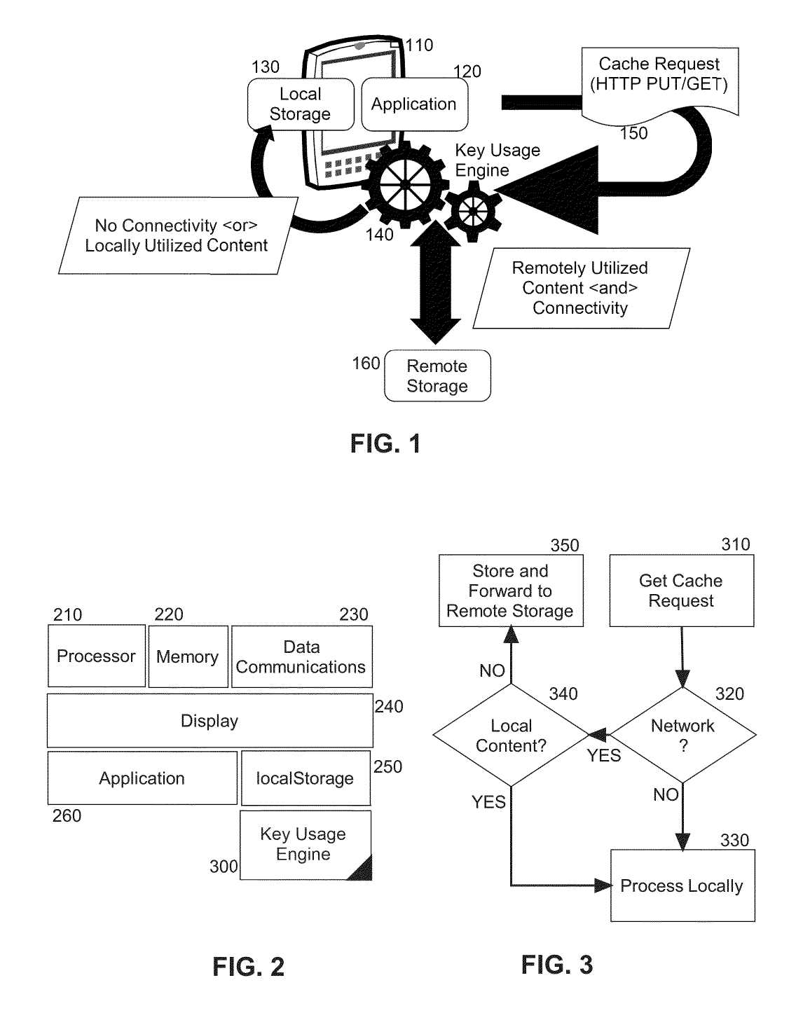

In further illustration, FIG. 1 pictorially shows a process for hybrid Web Storage performing mixed utilization of a localStorage object and remote storage. As shown in FIG. 1, an application 120 can execute in a mobile device 110. Cache requests 150 can be issued by the application 120, for instance HTTP PUT or GET requests for cached or cacheable content. In response to receiving a cache request 150, a key usage engine 140 can determine firstly, if network connectivity exists as between the mobile device 110 and remote storage 160. If not, the cache request 150 is processed in a localStorage object 130 established in the mobile device 110. Further, if the content requested as part of the cache request is content primarily only utilized locally within the mobile device 110, such as device and application configuration data, the cache request 150 is processed in the localStorage object 130. Otherwise, the cache request 150 is processed in remote storage 160. In this way, the key usage engine 140 effectuates a hybrid utilization both of localStorage and also of remote storage.

The process described in connection with FIG. 1 can be implemented in a content retrieval data processing system. In yet further illustration, FIG. 2 schematically shows a content retrieval data processing system configured for hybrid Web Storage performing mixed utilization of a localStorage object and remote storage. The system includes a mobile device that includes at least one processor 210, memory 220 and data communications circuitry 230 sufficient to transceive data wirelessly over a data communications network or cellular communications network. A display 240 also can be provided through which a user interface can be presented in connection with an application 260 executing in the memory 220 of the mobile device.

Of note, a key usage engine 300 can execute in the memory 220 of the mobile device. The key usage engine 300 includes program code that when executed in the memory 220 is enabled to receive a cache request by the application 260, to determine based upon at least detected network connectivity of the mobile device as reported by the data communications circuitry 230 whether to process the cache request in an HTML5 localStorage object 250 created in the mobile device, or to process the cache request in remote storage external from the mobile device over a computer communications network by way of the data communications circuitry 230, and to process the cache request in the localStorage object 250 responsive to a determination to process the cache request locally, but otherwise processing the cache request in the remote storage.

In even yet further illustration of the operation of the key usage engine 300, FIG. 3 is a flow chart illustrating a process for hybrid Web Storage performing mixed utilization of a localStorage object and remote storage. Beginning in block 310, a cache request can be received in the key usage engine from an application executing in a mobile device. The cache request can be an HTTP PUT request for a key-value pair, or an HTTP GET request also based upon a key-value pair. In decision block 320, it can be determined if network connectivity is available for the mobile device. If not, the cache request can be processed locally in a localStorage object. Otherwise the process can proceed through decision block 340.

In decision block 340, it can be determined whether or not the content associated with the key-value pair is primarily utilized locally in the mobile device, or primarily utilized remotely by multiple different other mobile devices. The former circumstance can include content such as application or device configuration data. The latter circumstance can include content such as user profile or user preference data. In any event, in decision block 340 if it is determined that the cache request refers to content primarily utilized locally in the mobile device, in block 330 the cache request is processed locally in the localStorage object of the mobile device. Otherwise, in block 350 the cache request is processed in remote storage through a store and forward mechanism.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for hybrid Web Storage performing mixed utilization of a localStorage object and remote storage, the method comprising:
receiving a cache request in a key usage engine of a mobile device by an application executing in the mobile device;
determining in the key usage engine based upon at least detected network connectivity whether to process the cache request in a hypertext markup language (HTML) version 5 localStorage object of the mobile device, or to process the cache request in remote storage external from the mobile device over a computer communications network; and,
processing the cache request in the localStorage object of the mobile device responsive to a determination by the key usage engine to process the cache request locally, but otherwise processing the cache request in the remote storage.

2. The method of claim 1, wherein the key usage engine determines whether to process the cache request locally in the localStorage object or remotely in remote storage in reference not only to detected network connectivity, but also in reference to a frequency of receipt of the cache request.

3. The method of claim 1, wherein the key usage engine determines whether to process the cache request locally in the localStorage object or remotely in remote storage in reference not only to detected network connectivity, but also in reference to whether data subject to the cache request is data of interest only to the mobile device or whether data subject to the cache request is data of interest to multiple different applications executing in multiple different mobile devices.

4. The method of claim 1, wherein the cache request is a hypertext transport protocol (HTTP) PUT request for a particular key-value pair.

5. The method of claim 1, wherein the cache request is a hypertext transport protocol (HTTP) GET request for a particular key-value pair.

6. The method of claim 4, wherein the PUT request is processed in the remote storage by way of a store and forward queue.

7. A content retrieval data processing system configured for hybrid Web Storage performing mixed utilization of a localStorage object and remote storage, the system comprising:
a mobile device comprising at least one processor and memory;
an application executing in the memory of the mobile device;
a hypertext markup language (HTML) version 5 localStorage object defined in the memory of the mobile device; and,
a key usage engine comprising program code enabled upon execution in the memory of the mobile device to receive a cache request by the application, to determine based upon at least detected network connectivity of the mobile device whether to process the cache request in the localStorage object, or to process the cache request in remote storage external from the mobile device over a computer communications network, and to process the cache request in the localStorage object responsive to a determination to process the cache request locally, but otherwise processing the cache request in the remote storage.

8. The system of claim 7, wherein the key usage engine determines whether to process the cache request locally in the localStorage object or remotely in remote storage in reference not only to detected network connectivity, but also in reference to a frequency of receipt of the cache request.

9. The system of claim 7, wherein the key usage engine determines whether to process the cache request locally in the localStorage object or remotely in remote storage in reference not only to detected network connectivity, but also in reference to whether data subject to the cache request is data of interest only to the mobile device or whether data subject to the cache request is data of interest to multiple different applications executing in multiple different mobile devices.

10. The system of claim 7, wherein the cache request is a hypertext transport protocol (HTTP) PUT request for a particular key-value pair.

11. The system of claim 7, wherein the cache request is a hypertext transport protocol (HTTP) GET request for a particular key-value pair.

12. The system of claim 10, wherein the PUT request is processed in the remote storage by way of a store and forward queue.

13. A computer program product for hybrid Web Storage performing mixed utilization of a localStorage object and remote storage, the computer program product comprising a computer readable storage medium having program instructions embodied therewith, the program instructions executable by a device to cause the device to perform a method comprising:
receiving a cache request in a key usage engine of a mobile device by an application executing in the mobile device;
determining in the key usage engine based upon at least detected network connectivity whether to process the cache request in a hypertext markup language (HTML) version 5 localStorage object of the mobile device, or to process the cache request in remote storage external from the mobile device over a computer communications network; and,
processing the cache request in the localStorage object of the mobile device responsive to a determination by the key usage engine to process the cache request locally, but otherwise processing the cache request in the remote storage.

14. The computer program product of claim 13, wherein the key usage engine determines whether to process the cache request locally in the localStorage object or remotely in remote storage in reference not only to detected network connectivity, but also in reference to a frequency of receipt of the cache request.

15. The computer program product of claim 13, wherein the key usage engine determines whether to process the cache request locally in the localStorage object or remotely in remote storage in reference not only to detected network connectivity, but also in reference to whether data subject to the cache request is data of interest only to the mobile device or whether data subject to the cache request is data of interest to multiple different applications executing in multiple different mobile devices.

16. The computer program product of claim 13, wherein the cache request is a hypertext transport protocol (HTTP) PUT request for a particular key-value pair.

17. The computer program product of claim 13, wherein the cache request is a hypertext transport protocol (HTTP) GET request for a particular key-value pair.

18. The computer program product of claim 16, wherein the PUT request is processed in the remote storage by way of a store and forward queue.
